(19) United States
(12) Patent Application Publication
(10) Pub. No.: US 2013/0141472 A1
(43) Pub. Date: Jun. 6, 2013

(54) LIQUID CRYSTAL STEREOSCOPIC DISPLAY SYSTEM AND A METHOD FOR DRIVING THE SAME

(71) Applicants: Xiao-Ping Tan, Shenzhen (CN); Nian-Mao Wang, Shenzhen (CN)

(72) Inventors: Xiao-Ping Tan, Shenzhen (CN); Nian-Mao Wang, Shenzhen (CN)

(21) Appl. No.: 13/497,236

(22) PCT Filed: Dec. 21, 2011
(86) PCT No.: PCT/CN2011/084328

§ 371 Date: Mar. 20, 2012

(30) Foreign Application Priority Data
Dec. 2, 2011 (CN) 201110395989.7

(51) Int. Cl. G09G 5/10; G09G 3/36

(52) U.S. Cl. 345/690; 345/102

(57) ABSTRACT

A liquid crystal stereoscopic display system and a method for driving the same are provided. The system includes an image display device, for displaying a right-eye image and a left-eye image in sequence according to a timing control signal; a shutter glass unit, having a right-eye lens and a left-eye lens, where the right-eye lens is in an open state or a closed state according to the timing control signal, and the left-eye lens is in an open state or a closed state according to the timing control signal; and a backlight unit, for providing a light source for a display panel unit, where the backlight unit performs an close action according to the timing control signal, and performs a open action before a next timing control signal is generated.

### FIELD OF THE INVENTION

The present invention relates to a liquid crystal stereoscopic display system, and in particular, to a stereoscopic display system using shutter glasses.

### BACKGROUND OF THE INVENTION

Display is a most important interface between human and science. The image display technology is developed towards high resolution, high quality, and large size. According to the next display technology, plane image display is converted into stereoscopic image display to meet the requirement of stereoscopic vision which is of the most importance in human vision.

In an autostereoscopic display, a plurality of images at different angles of view respective enters the left eye and the right eye, so that an observer can see a stereoscopic image without using special glasses. Presently, the stereoscopic image display may be classified into temporal multiplexed display and spatial multiplexed display. However, a problem that the stereoscopic display effect cannot be seen when the eyes deviates from an assigned position occurs.

In another stereoscopic display, shutter glasses are used. When playing an image, the stereoscopic display divides the image into a left-eye picture and a right-eye picture. When the display sets that the left-eye picture is played for the left eye to watch, the right eye is covered with the shutter glasses to ensure that only the left eye can see the picture. Then, when the display plays the right-eye picture for the right eye to watch, the left eye is covered to ensure that only the right eye can see the picture. In thus way, the stereoscopic image can be seen through alternation between the left-eye picture and the right-eye picture. However, the stereoscopic display has the disadvantage that in the switching process of the left-eye picture and the right-eye picture, the observer always sees the crosstalk phenomenon. Specifically, the crosstalk phenomenon refers to the situation that when the user watches a stereoscopic picture on a display through shutter glasses, the right-eye picture on the display does not completely disappear when a left-eye shutter of the shutter glasses is opened, so the observer of the display sees the right-eye image; or refers to the situation that when a right-eye shutter of the shutter glasses is opened, the left-eye image of the display does not completely disappear, so the observer sees the left-eye image, which easily occurs when the display is a liquid crystal display (LCD).

In the prior art, in order to eliminate the crosstalk phenomenon, a rapid-response liquid crystal material is used. FIG. 2 is a timing diagram of shutter glasses and a light-emitting unit in the prior art. As shown in FIG. 2, when a timing control unit sends a first signal, a light-emitting unit is in an ON state, and then is not controlled by any device and is in a constant ON state. When the first signal is sent, it is also indicated that the display is to display a left-eye picture, and at this time, the left-eye lens and the right-eye lens are both in a closed state. After a period of time, and till the left-eye picture is stabilized, the left-eye lens is opened, and the right-eye lens is still maintained in the closed state, till the timing control unit sends a second signal. When the second signal is sent, it is indicated that the display is to display the right-eye picture, so the left-eye lens is immediately changes into a closed state. After a period of time, till the right-eye picture is stabilized, the right-eye lens is opened, and the left-eye lens is still maintained in the closed state, till the timing control unit sends a third signal. When the third signal is sent, it is indicated that the display is to display the left-eye picture, so the right-eye lens is changed into a closed state, till the left-eye picture is stabilized, the left-eye lens is opened, and the right-eye lens is still maintained in the closed state. In this way, the left-eye lens and the right-eye lens is alternately opened and closed according to a signal of the timing control unit, and the process is repeated, while the light-emitting unit is in a constant ON state. The dotted lines in the timing diagram of the left-eye lens and the right-eye lens in FIG. 2 represent the schematic open and close processes.

By adopting the technology, the crosstalk phenomenon can be reduced. However, the method has a disadvantage as follows. The stereoscopic picture is switched at a high frequency, which needs to be 120 Hz or higher, so as to eliminate physical discomfort of the user caused by picture switching. Meanwhile, the response speed of active shutter glasses is required to be very high, otherwise the pictures seen by the left eye and the right eye cannot be distinguished. In order to achieve the rapid response effect, the material of lenses in the active shutter glasses are generally rapid-response liquid crystal material, while the responses speed of the glasses required by the technology is higher, resulting in high cost of the liquid crystal glasses.

Therefore, in the present invention, driving timing of the light-emitting unit and the glasses are changed, so that no rapid-response liquid crystal material needs to be used in the manufacturing process of the active shutter glasses, thereby reducing the cost of the active shutter glasses.

### SUMMARY OF THE INVENTION

In order to solve the above problems, the present invention is directed to a method for driving a liquid crystal stereoscopic display system, so as to reduce the manufacturing cost and achieve a good stereoscopic display effect through controlling timing of a backlight module and three-dimensional (3D) glasses.

The present invention adopts the following technical solutions to solve the above technical problems. The liquid crystal stereoscopic display system comprises a backlight module, an image display device, and a shutter glass device. The image display device is used for displaying a right-eye image and a left-eye image. The shutter glass device comprises a left-eye lens and a right-eye lens. The method further comprises: receiving a timing control signal; according to the timing control signal, turning off the backlight module, and turning on the backlight module before a next timing control signal is generated; and according to the timing control signal, when the left-eye image is displayed, opening the left-eye lens and closing the right-eye lens.

In order to solve the above problems, the present invention provides a liquid crystal stereoscopic display system, so as to reduce the manufacturing cost and achieve a good stereoscopic display effect.

The present invention adopts the following technical solutions to solve the above technical problems. A liquid crystal stereoscopic display system is provided, which includes an image display device, for displaying a right-eye image and a left-eye image in sequence according to a timing control signal; a shutter glass device, having a right-eye lens and a left-eye lens, where the right-eye lens is in an open state or a closed state according to the timing control signal, and the left-eye lens is in an open state or a closed state according to the timing control signal; and a backlight module, for providing a light source for the image display device, where the backlight module performs an close action according to the timing control signal, and performs a open action before a next timing control signal is generated.

The present invention is characterized in that, an open duration of the right-eye lens and an open duration of the left-eye lens of the shutter glass device and an open duration and a closed duration of the light emitting module are control, so as to reduce the crosstalk phenomenon, so that no rapid-response liquid crystal material needs to be used in the manufacturing process of the liquid crystal stereoscopic display system, thereby reducing the cost of the liquid crystal stereoscopic display system.

### BRIEF DESCRIPTION OF THE DRAWINGS

The present invention will become more fully understood from the detailed description given herein below for illustration only, and thus are not limitative of the present invention, and wherein:

FIG. 1 is a schematic diagram of a circuit system of a liquid crystal stereoscopic display system according to an exemplary embodiment;

FIG. 2 is a timing diagram of a circuit device in the prior art; and

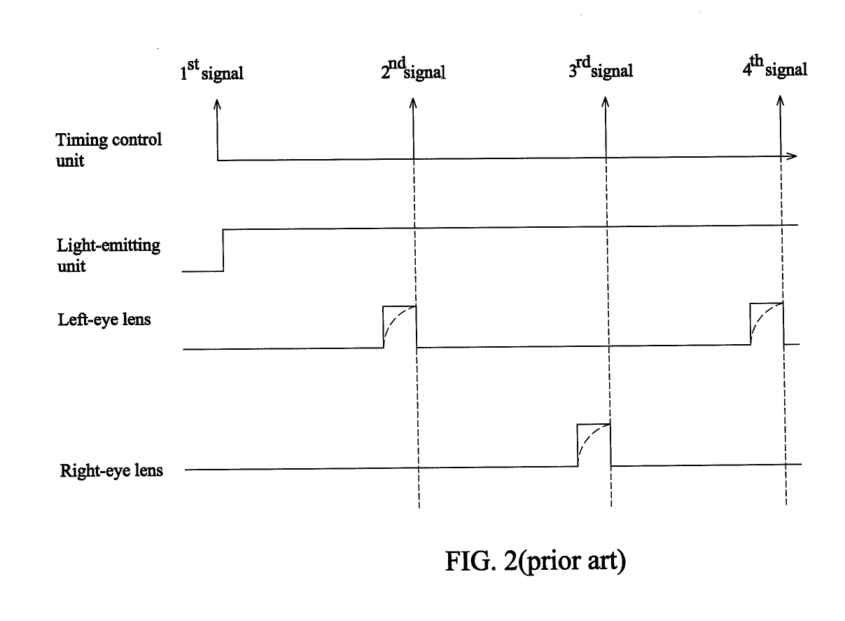

FIG. 3 is a timing diagram of a circuit device according to an exemplary embodiment of the present invention.

### DETAILED DESCRIPTION OF THE INVENTION

Exemplary embodiments of the present invention are described in detail below with reference to the accompanying drawings.

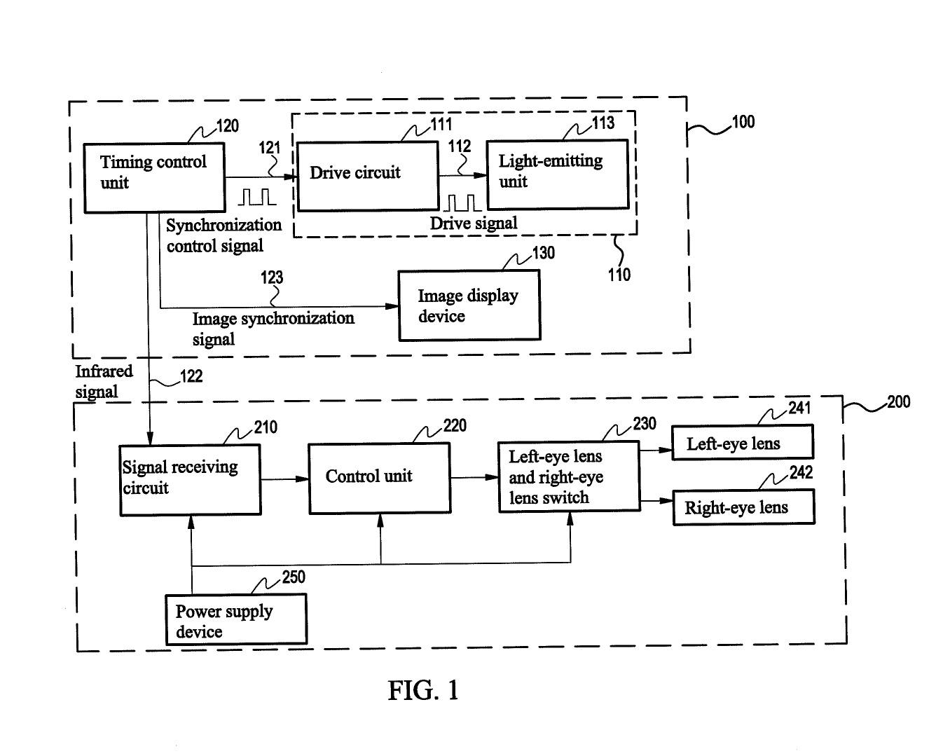

FIG. 1 is a schematic diagram of a circuit system of a liquid crystal stereoscopic display system according to an exemplary embodiment. The liquid crystal stereoscopic display system of this embodiment includes a display 100 and 3D glasses 200.

When using the liquid crystal stereoscopic display system, a user needs to wear the 3D glasses 200 to watch images displayed by the display 100.

Circuit systems and actions of the display 100 and the 3D glasses 200 are described below.

First, the display 100 is described. The display 100 includes a timing control unit 120, a backlight module 110, and an image display device 130, where the backlight module further includes a drive circuit 111 and a light-emitting unit 113.

The timing control unit 120 sends a timing control signal to the backlight module 110, the image display device 130, and the 3D glasses 200, so that each device has a signal to follow.

The timing control unit 120 is electrically connected to the backlight module 110 and the image display device 130, so as to send a signal through an electronic circuit. A timing control signal received by the image display device 130 from the timing control unit 120 is defined as an image synchronization signal 123, and the image display device 130 displays a left-eye image and a right-eye image in sequence according to the image synchronization signal 123.

The backlight module 110 is mainly used for providing a light source for the image display device 130, wherein the drive circuit 111, as a device that receives the timing control signal sent by the timing control unit 120, defines the timing control signal as a synchronization control signal 121. The drive circuit 111 determines when to turn on the light-emitting unit 113, when to turn off the light-emitting unit 113 according to the synchronization control signal 121, and controls the luminance of light-emitting unit 113 according to the synchronization control signal 121, and sends a drive signal 112 to the light-emitting unit 113.

The light-emitting unit 113 in the backlight module is electrically connected to the drive circuit 111, which is convenient for the drive circuit 111 to send the drive signal 112 through an electronic circuit. The light-emitting unit 113 is in an ON state or OFF state according to the drive signal 112. When the light-emitting unit 113 is turned on, a user can see the left-eye image or the right-eye image displayed by the image display device 130, and light-emitting unit 113 is turned off, although the image display device 130 displays the left-eye image or the right-eye image, but the user cannot see any image due to the absence of the light of the light-emitting unit.

The user needs to wear the 3D glasses 200 to watch the display, and can see a stereoscopic image. In the following, a circuit structure of the 3D glasses 200 is described.

The 3D glasses 200 includes a signal receiving circuit 210, a control unit 220, a left-eye lens and right-eye lens switch 230, a power supply device 250, a left-eye lens 241, and a right-eye lens 242, and all the elements are electrically connected to each other.

When using the 3D glasses 200, the user needs to turn on the power supply device 250. The power supply device 250 is electrically connected to different circuits, units, switches, and structures, and supplies different levels of energy to turn on them. When the signal receiving circuit 210 is turned on, the signal receiving circuit 210 receives the timing control signal from the timing control unit 120. Because the timing control unit 120 sends the signal in the form of infrared to the signal receiving circuit 210, the signal is defined as an infrared signal 122.

When receiving the infrared signal 122, the signal receiving circuit 210 converts the infrared signal 122 into an electronic signal according to the content of the infrared signal 122 and sends the electronic signal to the next-level control unit 220. The control unit 220 determines whether the signal is correct and the content of the signal, and sends a signal to the left-eye lens and right-eye lens switch 230 after determining the content of the signal.

The left-eye lens and right-eye lens switch 230 controls to turn on or turn off the left-eye lens and right-eye lens of next-level according to the signal received from the control unit 220.

The timing control unit 120, the drive circuit 111, the control unit 220, and the left-eye lens and right-eye lens switch 230 may be a chip set, a processor such as a CPU and an MPU, other auxiliary circuits, operation software, firmware, or a relevant module, element, and software, but is not limited to.

The light-emitting unit 110 may be light-emitting diodes, a lamp, other auxiliary circuits, or other light-emitting elements, but is not limited to.

The image display device 130 may be a transmission liquid crystal panel, a transflective liquid crystal panel, or other auxiliary circuits, but is not limited to.

The left-eye lens 241 and the right-eye lens 242 include a liquid crystal panel with a transparent electrode and other auxiliary circuits, but are not limited to.

The power supply device may be a built-in power supply device or an external power supply device. The built-in power supply device may be a general battery, lithium battery, rechargeable battery, a solar cell, or other auxiliary circuits.

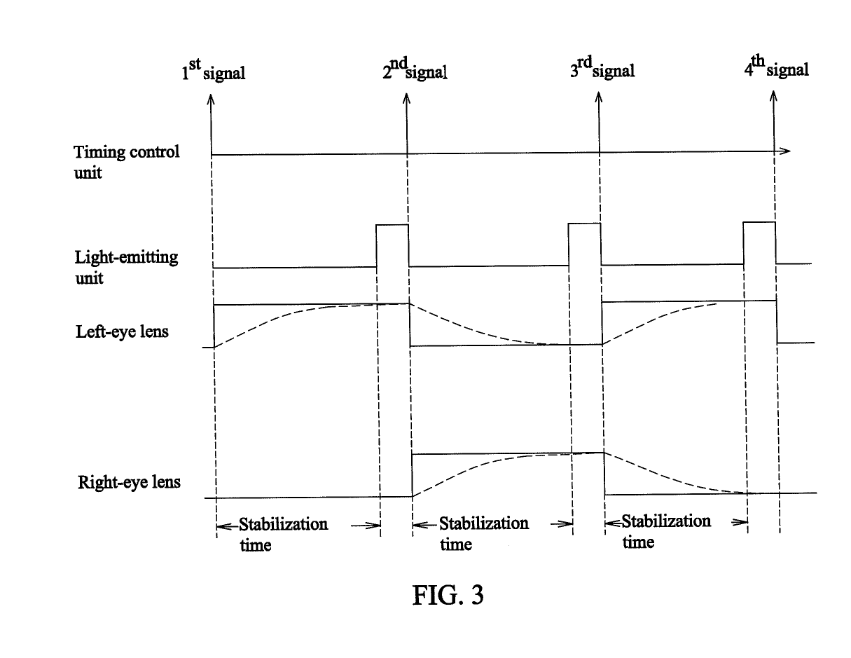

FIG. 3 is a timing diagram of a circuit device according to an exemplary embodiment of the present invention. When timing control unit sends a 1^{st} signal, it is indicated that the image display device is to display a left-eye picture, and at this time, the left-eye lens needs to be immediately in an open state, and the right-eye lens needs to be in a closed state. However, due to the factor of being of a liquid crystal material, the left-eye lens is completely in an open state after a period of stabilization time. After the period of stabilization time, the left-eye lens is completely in an open state. Till the timing control unit sends a 2^{nd} signal, the light-emitting unit is in a closed state. The dotted lines in the timing diagram of the left-eye lens present the schematic open and close processes.

When the timing control unit sends a 2^{nd} signal, it is indicated that image display device is to display a right-eye picture, and at this time, the light-emitting unit and the left-eye lens need to be immediately in a closed state, and the right-eye lens needs to be immediately in an open state. However, due to the factor of being of a liquid crystal material, the right-eye lens is completely in an open state after a period of stabilization time. After the period of stabilization time, the right-eye lens is in an open state, and then the light-emitting unit is turned on. Till the timing control unit sends a 3^{rd} signal, the light-emitting unit is in a closed state. The dotted lines in the timing diagram of the right-eye lens represent the schematic open and close processes. When the timing control unit sends a signal, the light-emitting unit, the left-eye lens, and the right-eye lens are turned on or turned off in sequence.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claim.

What is claimed is:

1. A method for driving a liquid crystal stereoscopic display system, wherein the liquid crystal stereoscopic display system comprises a backlight module, an image display device, and a shutter glass device, the image display device is used for displaying a right-eye image and a left-eye image, and the shutter glass device comprises a left-eye lens and a right-eye lens, the method comprising:
generating a timing control signal;
according to the timing control signal, turning off the backlight module, and turning on the backlight module before a next timing control signal is generated; and
according to the timing control signal, when the left-eye image is displayed, opening the left-eye lens and closing the right-eye lens.

2. The method for driving a liquid crystal stereoscopic display system according to claim 1, further comprising: according to the timing control signal, when the right-eye image is displayed, opening the right-eye lens and closing the left-eye lens.

3. The method for driving a liquid crystal stereoscopic display system according to claim 1, wherein an open duration of the backlight module is less than an open duration of the right-eye lens or the left-eye lens.

4. The method for driving a liquid crystal stereoscopic display system according to claim 1, wherein according to the timing control signal, a closed duration and an open duration of the backlight module and the luminance of the backlight module when being turned on are controlled.

5. A liquid crystal stereoscopic display system, comprising:
an image display device, for displaying a right-eye image and a left-eye image in sequence according to a timing control signal;
a shutter glass device, having a right-eye lens and a left-eye lens, wherein the right-eye lens is in an open state or a closed state according to the timing control signal, and the left-eye lens is in an open state or a closed state according to the timing control signal; and
a backlight module, for providing a light source for the image display device, wherein the backlight module performs an close action according to the timing control signal, and the backlight module performs a open action before a next timing control signal is generated.

6. The liquid crystal stereoscopic display system according to claim 5, further comprising a timing control unit, for providing the timing control signal to the image display device, the shutter glass device, and the backlight module.

7. The liquid crystal stereoscopic display system according to claim 6, wherein the timing control unit is electrically connected to the image display device and the backlight module, the timing control unit outputs the timing control signal in the form of infrared, and the timing control signal is received by the shutter glass device.

8. The liquid crystal stereoscopic display system according to claim 5, wherein when the right-eye lens is in an open state, the left-eye lens is in a closed state, and when the right-eye lens is in a closed state, the left-eye lens is in an open state.

9. The liquid crystal stereoscopic display system according to claim 5, wherein an open duration of the backlight module is less than an open duration of the right-eye lens or the left-eye lens.

10. The liquid crystal stereoscopic display system according to claim 5, wherein the backlight module has a drive circuit and a light-emitting unit, the drive circuit controls a closed duration and an open duration of the light-emitting unit and the luminance of the backlight module when being turned, according to the timing control signal.
